(19) United States
(12) Patent Application Publication
(10) Pub. No.: US 2025/0038948 A1
(43) Pub. Date: Jan. 30, 2025

(54) CONTROL DEVICE FOR A SWITCHING VOLTAGE REGULATOR AND CONTROL METHOD

(71) Applicant: STMicroelecteronics International N.V., Geneva (CH)

(72) Inventor: Amedeo Veneroso, Caserta (IT)

(21) Appl. No.: 18/769,801

(22) Filed: Jul. 11, 2024

(30) Foreign Application Priority Data
Jul. 26, 2023 (IT) 102023000015678

(51) Int. Cl. H04L 9/00; H04L 9/08

(52) U.S. Cl. CPC H04L 9/008; H04L 9/085

(57) ABSTRACT

A method comprising encrypting data values by a fully homomorphic encryption using a secret key to obtain encrypted data values, aggregating encrypted remote data in an encrypted aggregated value by performing a sum of the respective encrypted data values, performing one or more functions on the basis of the set of data values at the using entity, supplying the encrypted aggregated value to the using entity, which is configured to receive the secret key from a separated entity, decrypting the encrypted aggregated value using the secret key to obtain a decrypted sum of data values, performing data-related functions on the basis of the decrypted sum of the respective data values at the using entity.

### CROSS-REFERENCE TO RELATED APPLICATIONS

This application claims priority to Italian Application No. 102023000015678, filed on Jul. 26, 2023, which application is hereby incorporated by reference herein in its entirety.

### TECHNICAL FIELD

The embodiments of the present disclosure relate to encrypted data between collecting stations and remotely located local entities.

### BACKGROUND

It is known that there is a need to transmit data values that are acquired or collected, in particular, measured, in a given environment in a privacy-protected manner using encryption.

Under this view, a smart meter is a utility metering device (e.g., gas, energy, electricity, water), that collects, acquires, or measures data values (e.g., utility consumption values, such as energy consumption values), and that is connected to the Internet and can be augmented by a secure element that performs cryptographic operations (like signatures, etc.) on the collected data. Smart meters may have multiple benefits for energy management, especially during an energy crisis, as they allow automated meter reading, improved load forecasting and network management, energy and emissions reductions obtained from real-time informational feedback, and demand shifting, which may result in economic benefits.

However, smart metering presents a significant privacy risk, so several regulatory safeguards are instituted. Socio-economic and demographic information regarding metered appliances may be included among the data collected.

### SUMMARY

Considering the foregoing, an object of various embodiments of the present disclosure is to provide solutions that are able to overcome one or more of the limits of the prior art.

According to one or more embodiments, one or more of the previous objects are achieved by a method for transmitting data values privacy protected by encryption having the distinctive elements specified in the ensuing claims. The embodiments moreover concern a corresponding system for transmitting data values privacy protected by encryption.

The claims are integral to the technical teaching of the disclosure provided herein.

As mentioned previously, various embodiments of the present disclosure regard a method for transmitting data values privacy protected by encryption from a set of data collecting stations collecting respective data values from a respective environment and transmitting the respective set of data values to a using entity located remotely with respect to the collecting stations, the method comprising encrypting the set of data values by a fully homomorphic encryption using a secret key to obtain a plurality of respective encrypted data values, aggregating the encrypted remote data of at least a subset of the set of the encrypted remote data in a respective encrypted aggregated value performing a sum of the respective encrypted data values of the at least a subset, the encrypting being performed before the aggregating, in particular at the collecting stations, performing one or more functions on the basis of the set of data values at the using entity, the method further comprising supplying the at least one encrypted aggregated value to the using entity, which is configured to receive the secret key from a separated entity, in particular a server or a cloud, decrypting using the secret key at the at least a using entity the at least one encrypted aggregated value obtaining a decrypted sum of respective data values, performing one or more data-related functions on the basis of the decrypted sum of the respective data values at the using entity.

In variant embodiments, the data values are utility consumption values, obtained by a smart metering of utility consumption values, comprising measuring a set of measured utility consumption values consumed by respective utility consuming environments by respective smart utility meters, supplying the measured utility values to at least a utility consumption using entity located remotely with respect to the utility consuming environments, performing one or more functions on the basis of the set of measured utility values at the using entity.

In variant embodiments, the utility consumption values are energy consumption values and the smart utility meters are smart energy meters.

In variant embodiments, the encrypting the set of data values by a fully homomorphic encryption using a secret key to obtain a plurality of respective encrypted collected data values, comprises, given an integer number and a ring defining integer identifying a ring of integers modulo the ring defining integer; generate a number N of random numbers, i.e. belonging to a set of N-vectors over the ring; compute a summation modulo the ring defining integer of each j-th random number in the number N of random numbers while a corresponding secret key binary coefficient is equal to one; to the summation, also add a data value to encrypt as plaintext; finally, add a Gaussian noise e, obtaining a learning with errors (LWE) summation value, as the the sum of the data value and the summation modulo the ring defining integer plus the noise obtain a LWE ciphertext a vector comprising as elements the random numbers and the LWE summation as last element corresponding to an encrypted data value (E), and the decryption comprises using the secret key at the at least a data value using entity, the at least one encrypted aggregated value (E, E) obtaining a decrypted sum of respective collected data values, comprising: compute a summation modulo the ring defining integer of each j-th random number in the number N of random numbers while a corresponding secret key binary coefficient is equal to one; subtract the summation modulo the ring defining integer from the last component of the ciphertext corresponding to an encrypted data value (E), which is the LWE summation value, obtaining a decrypted data value.

In variant embodiments, the using entity is a power station that distributes energy to the environments as a function of the sum of the respective measured energy values at the energy consumption using entity.

In variant embodiments, the stations in the set of collecting stations comprise a respective Secure element and the separated entity shares with each secure element a set of Zero Tokens, corresponding to an encrypted zero data value encrypted by the encryption operation, each identified by a respective identifier, stored previously in the Secure Element with respect to encryption operations, in particular when the Secure Element is created, during the encryption, the Secure Element is configured to randomly select a subset of the set of zero tokens, and generate respective random scalar weights and a vector containing the scalar weights, the identifiers and the encrypted sum of data values, corresponding to the encrypted data value (E), which are sent to the using entity through the respective aggregator, decrypting at the using entity using the pre-shared token identifier and the weights to compute the total of the collected data values as subtraction of the result to the last component of the encrypted data values (E).

In variant embodiments, the sending to the using entity through the respective aggregator includes aggregating the encrypted data values (E) of at least a subset of the set of the encrypted measured data values and sending to the using entity all the corresponding scalar weights and identifiers and a total sum of each encrypted sum data value of the corresponding subset of smart meters.

In variant embodiments, the encrypted measured data values are aggregated without decrypting encrypted measured data values.

In variant embodiments, the secret key is available only to an entity used for decryption.

In variant embodiments, the secret key is stored in a secure element accessible to a station or smart meter for performing encryption.

Variant embodiments of the solution here described regard also a system for transmitting data values privacy protected by encryption from a set of data collecting stations collecting respective data values from a respective environment and transmitting the respective set of data values to a using entity located remotely with respect to the collecting stations, a data values using entity located remotely with respect to the data value consuming environments to which the set of stations is configured to supply the measured data values, the data values using entity being configured to perform one or more functions on the basis of the set of collected data values, the system being configured to encrypt the measured data values by a fully homomorphic encryption using a secret key to obtain a plurality of respective encrypted data values, the system comprising one or more aggregating entity configured to aggregate the encrypted data values of at least a subset of the set of the encrypted data values in a respective encrypted aggregated value performing a sum of the respective encrypted data values of the at least a subset, the encryption being performed before the aggregating, in particular at the stations, the one or more aggregating entity being configure to supply the at least one encrypted aggregated value to the at least a data values consumption using entity located remotely with respect to the data using environments, which is configured to receive the secret key from a separated entity, in particular a server or a cloud, the data value using entity being configure to decrypt using the secret key the at least one encrypted aggregated value obtaining a decrypted sum of respective collected data values, and to perform one or more data-related functions on the basis of the sum of the respective collected data values at the data values using entity.

In variant embodiments, the data values are utility consumption values, obtained by a smart metering of utility consumption values, comprising measuring a set of measured utility consumption values consumed by respective utility consuming environments by respective smart utility meters, supplying the measured utility values to at least a utility consumption using entity located remotely with respect to the utility consuming environments, performing one or more functions on the basis of the set of measured utility values at the using entity.

In variant embodiments, the utility consumption values are energy consumption values and the smart utility meters are smart energy meters.

In variant embodiments, the encrypting of the collected data value using a secret key to obtain a plurality of respective encrypted measured data values by fully homomorphic encryption using the secret key to obtain the encrypted measured data values comprises generating a number of random numbers; computing a sum of a j-th random number if a corresponding secret key coefficient is equal to one to the sum, also adding the data value to encrypt add a Gaussian noise, the performing at the using entity fully homomorphic decryption of the encrypted data values using the secret key comprising computing a sum of a j-th random number if a corresponding secret key coefficient is equal to one; subtract the result to the last component of the encrypted data values.

In variant embodiments, the using entity is a power station that distributes energy to the environments as a function of the sum of the respective measured energy values at the energy consumption using entity.

In variant embodiments, the data collecting station comprises a respective Secure element, and the separated entity shares with each secure element a set of Zero Tokens, corresponding to an encrypted zero value of the data encrypted by the encryption operation, each identified by a respective identifier, stored previously in the Secure Element with respect to encryption operations, in particular when the Secure Element is created,
during the encryption, the Secure Element is configured to randomly select a subset of the set of zero tokens, and generate respective random scalar weights and a vector containing the scalar weights, the identifiers, and the encrypted sum data value corresponding to the encrypted data value (E), which are sent to the using entity through the respective aggregator, the using entity is configured to decrypt using the pre-shared token identifiers and the weights to compute the total of the collected data values as subtraction of the result to the last component of the encrypted data values.

In variant embodiments, the aggregator is configured to aggregate the encrypted data values of at least a subset of the encrypted data values and send to the using entity all the corresponding scalar weights and identifiers and a total sum of each encrypted sum of data values of the corresponding subset of smart meters.

In variant embodiments, the smart meter is configured to access a secure element storing the secret key; in particular, the secure element is comprised of the smart meter.

In variant embodiments, the data values are utility consumption values, obtained by a smart metering of utility consumption values, comprising measuring a set of measured utility consumption values consumed by respective utility consuming environments by respective smart utility meters, supplying the measured utility values to at least a utility consumption using entity located remotely with respect to the utility consuming environments, performing one or more functions on the basis of the set of measured utility values at the using entity.

In variant embodiments, the utility consumption values are energy consumption values and the smart utility meters are smart energy meters.

### BRIEF DESCRIPTION OF THE DRAWINGS

The embodiments of the present disclosure will now be described with reference to the annexed drawings, which are provided purely by way of non-limiting example, and in which:

FIG. 1 shows schematically a metering system;

FIG. 2 shows block schematics of a fully homomorphic encryption method;

FIG. 3 shows schematically a metering system according to embodiments;

FIG. 4 shows a further block schematic showing further aspects of the metering system according to embodiments; and

FIG. 5 shows a flow diagram of a method according to embodiments.

### DETAILED DESCRIPTION OF ILLUSTRATIVE EMBODIMENTS

In the ensuing description, various specific details are illustrated, aimed at providing an in-depth understanding of the embodiments. The embodiments may be provided without one or more of the specific details, or with other methods, components, materials, etc. In other cases, known structures, materials, or operations are not illustrated or described in detail so that various aspects of the embodiments will not be obscured.

Reference to “an embodiment” or “one embodiment” in the framework of the present disclosure is intended to indicate that a particular configuration, structure, or characteristic described in relation to the embodiment is comprised of at least one embodiment. Hence, phrases such as “in an embodiment” or “in one embodiment” that may be present in various points of this description do not necessarily refer to one and the same embodiment. Moreover, particular conformations, structures, or characteristics may be combined in any adequate way in one or more embodiments.

The references used herein are provided only for convenience and do not define the sphere of protection or the scope of the embodiments.

In embodiments, the disclosure refers to solutions for smart metering of energy consumption values, comprising measuring a set of measured energy values consumed by respective energy-consuming environments by respective smart energy meters and supplying the measured energy values to at least an energy consumption using entity located remotely with respect to the energy consuming environments, performing one or more energy-related functions, on the basis of the set of measured energy values at the energy consumption using entity, such data being supplied encrypted and decrypted at the using station.

More in particular, the solutions here described are to a using entity embodied by a power station. Performing one or more energy-related functions may include monitoring or energy distribution controlling or billing.

The solution here described in general refers to a method for transmitting data values, which may correspond in preferred to utility, in particular, energy values privacy protected by encryption, from a set of data collecting stations, preferably, smart metering stations, collecting, in particular by measuring, respective data values from a respective environment and transmitting the respective set of data values, e.g., utility, in particular, energy values to a using entity, e.g. the power station PS located remotely with respect to the collecting stations. Thus, while preferably data values are utility consumption, in particular energy consumption, values, measured in utility consumption, in particular energy consumption, environments, the data values could be any data value that can be collected in an environment and can be aggregated by a sum in an aggregator before being sent to the using station. Besides consumption, data values can, in embodiment, represent votes, for example, electoral votes, student scores, physical statistical data, or company information data, such as the annual income of the shops of a company, which can be aggregated by sum in an aggregator before being sent to the using station.

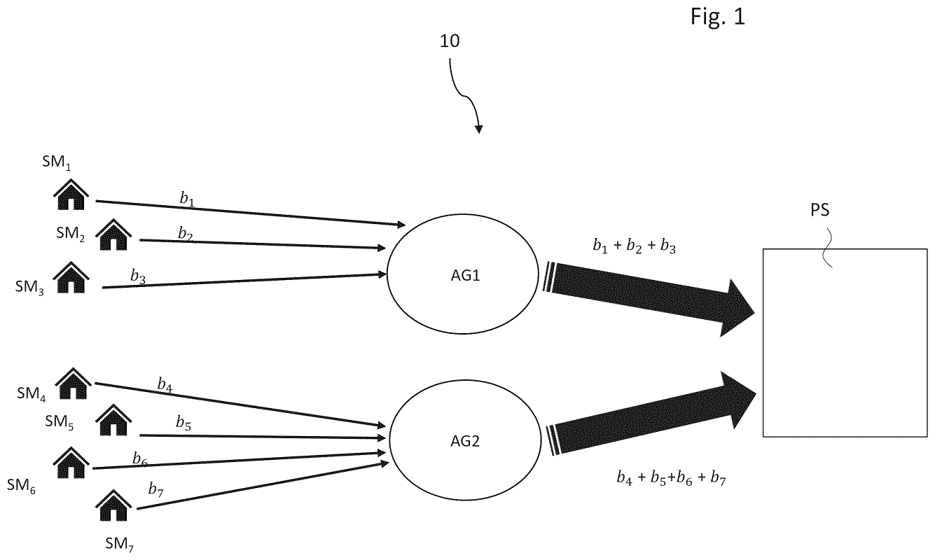

FIG. 1 illustrates a schematic of a system architecture of meters 10, comprising a plurality (i.e., a set) of smart meter SMᵢ, each sending a data value as measured energy value bᵢ, e.g. an energy balance, of a respective metered environment, for example, a single house.

In FIG. 1, an index i goes from 1 to K, where in the example, K is 7, representing the respective smart meter SMi, which is associated with a respective metered environment. A subset of smart meter SM₁-SM₃ feeds their measured energy values b1-b3 to a first respective aggregator module AG1, which is configured to sum the energy values b1 to b3, supplying a first sum (i.e., aggregated value equal to b₁+b₂+b₃ to a power station PS).

In the same way, energy values b4 to b7 are supplied to a second aggregator AG₂, supplying a second sum equal to b₄+b₅+b₆+b₇ to the power station PS. Of course, there can be a different number of aggregators or different aggregations of the energy values. The aggregators AG₁ and AG₂ are placed locally, e.g., correspond to aggregators aggregating measured energy values or balance of energy-consuming environments (e.g., a house) of the same town. In the example shown, there is an aggregator for each town and SM₁-SM₃ are the smart meters of the first town, and SM₄-SM₇ are the smart meters of the second town.

In such an architecture of smart meters SMᵢ, the problem then becomes how the power station PS, which performs the task of dimensioning and distributing energy to the users (e.g., to the environments or houses in which are applied the smart meters SMᵢ), can collect data with minimum impact on user privacy.

This can be performed by encrypting such collected data. For instance, fully homomorphic encryption is a way to encrypt data that allows arithmetic operation over the encrypted data.

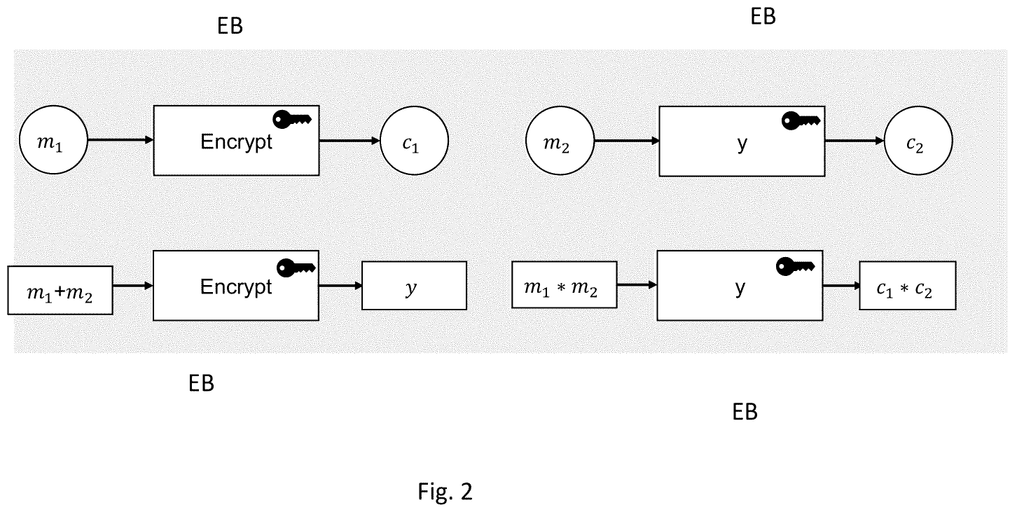

FIG. 2 illustrates a schematic of the fully homomorphic encryption, where the first input data m1 is encrypted in an encryption block EB, which outputs the first encrypted data cᵢ and second input data m₂ is encrypted in the encryption block 11, which outputs the second encrypted data c1. Encryption block 11 uses a user secret key s for the encryption of data. As shown, the fully homomorphic encryption EB can operate as well on the sum of input data m1+m2, outputting a sum of c1 and c2, or on the product m1*m2 outputting the product of the encrypted data c1*c2.

Besides input data being encrypted by a user secret key, arithmetic operations are thus performed “blindly” on encrypted data and the results can be decrypted only by using the user key.

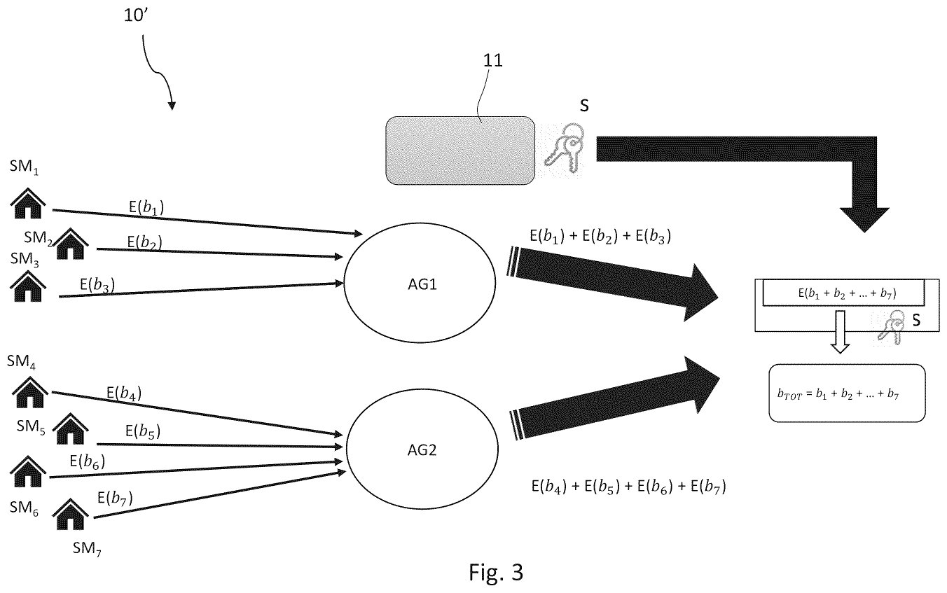

FIG. 3 shows an architecture of a system of meters 10′ adapted to implement the method described here. Such system of meters 10′ comprises as well the plurality of smart meter SMᵢ, each sending in this case an encrypted energy balance E(bᵢ), encrypted by a Fully Homomorphic Encryption of the respective metered environment, e.g., a single house, grouped in the example in the same manner by aggregators AG₁, AG₂, which in this case sum the encrypted energy balances, sending respective encrypted sum E(b₁+b₂+b₃) and E(b₄+b₅+b₆+b₇) to the power station PS. The power station PS receives from a server 11 a secret encryption key s and is configured to obtain a total encrypted energy balance E(b₁+b₂+b₃+b₄+b₅+b₆+b₇) summing together the sums from the aggregators AG₁, AG₂. Then the power station PS is configured to perform a decryption of the total encrypted balance E(b₁+b₂+b₃+b₄+b₅+b₆+b₇) obtaining a total energy balance bₜₒₜ=b_{y}+b₂+b₃+b₄+b₅+b₆+b₇.

The power station PS, in this way, knows only the total consumption, i.e., total measured energy or energy balance bₜₒₜ, since it has the secret key s for the decryption, of, e.g. E(b₁+b₂+b₃) from the aggregator AG₁ or E(b₄+b₅+b₆+b₇) from aggregator AG₂, on the basis which, for instance, understand how much energy to divert to the respective aggregator or subset of smart meters, but it does not know or it cannot know the single environment balance bᵢ (i.e., b₁, b₂, b₃, b₄, b₅, b₆, b₇).

Each aggregator AG₁, AG₂, which is usually placed locally, i.e. remote with respect to the power station PS and preferably local with respect to the town or subset of smart meters/environments to which it is associated, does not know the energy balances of the corresponding subset of smart meters, e.g. town, contributing their respective energy balances to such aggregator because it does not have the secret key s at disposal.

Thus, such aggregating the encrypted measured energy values E(b₁) . . . E(b₇) is performed without decrypting encrypted measured energy values, E(b₁) . . . E(b₇). Also, in embodiments, such secret key s may be made available for decryption only to a using entity PS, i.e., an entity that uses the decrypted energy for an energy managing function of the system, in particular excluding aggregators.

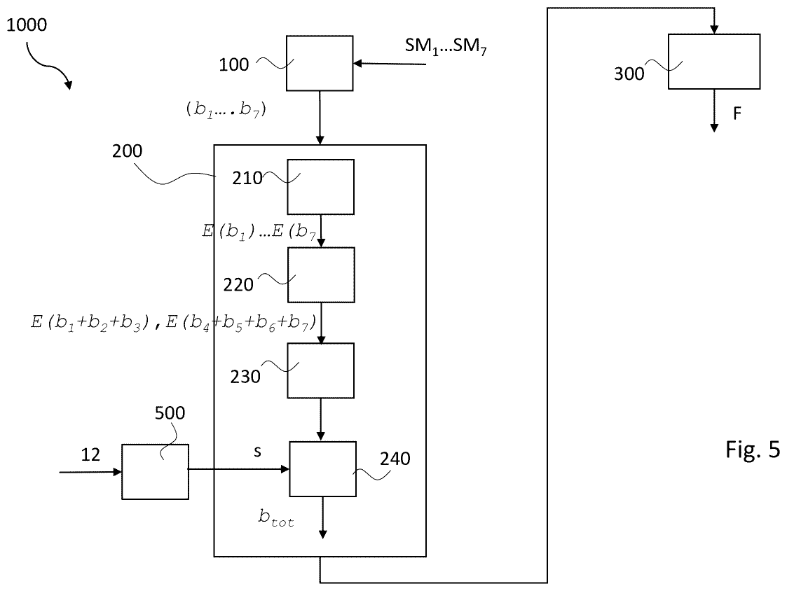

Now, the fully homomorphic encryption method, an embodiment of which is indicated with 1000 in the following with reference to FIG. 5, used by the solution described here, is explained in general.

An LWE (Learning With Errors) ciphertext c encrypting a plaintext p under a secret key s is a tuple c∈( [symbol] q)^{N+1} is obtained as follows.

Given an integer number N and an integer number k, with q=2^{k} being an integer identifying the ring of integers modulo q [symbol] q= [symbol] /q [symbol] : generate a number N of random numbers (rand1, rand2, . . . , rand_{N})∈( [symbol] q)^{N}, i.e. belonging to a set of N-vectors over the ring [symbol] q; compute a summation (mod q) of the j-th random number randⱼ with j index from 1 to N, if the corresponding secret key coefficient sⱼ=1, i.e. compute Σⱼ₌₁^{N}sⱼrandⱼ(mod q); to the summation, also add the value to encrypt (i.e., the plaintext p); finally, add a Gaussian noise e, obtaining a LWE summation value suml: lsum=p+Σⱼ₌₁^{N}sⱼrandⱼ+e (mod q), where N, k∈ [symbol] =2^{k}, B={0,1}, s=(s1, s2, . . . , s_{N})∈B^{N}, p∈ [symbol] q= [symbol] /q [symbol] , the cyphertext c belonging to ( [symbol] q)^{N+1}. The LWE summation value lsum is the sum of the plaintext and of the sum (mod q) of the j-th random number rand1 which secret key coefficient sⱼ is 1, plus the noise e.

Then, finally the LWE ciphertext computed is c=(rand1, rand2, . . . , rand_{N}, lsum), i.e. a vector comprising as elements the random numbers and the LWE summation as last element.

Operations are performed, for instance, on 64-bit integers. With an adequate level of security (lambda=128, lambda being an indication of the desired security level of the scheme. For instance, 128-bit security (λ=128), as per the Homomorphic Encryption Standard (at URL:http://homomorphicencryption.org/wp-content/uploads/2018/11/HomomorphicEncryptionStandardv1.1.pdf)N=630.

Under this view, the LWE ciphertext computed is c=(rand1, rand2, . . . , rand_{N}, suml) may have a size around 5 kb.

Given again N, k∈ [symbol] , q=2^{k}, B={0,1}, s=(s1, s2, . . . , s_{N})∈B^{N}, an LWE ciphertext c=(rand1, rand2, . . . , rand_{N}, suml)∈( [symbol] q)^{N+1}, the decryption of the cyphertext c under the secret key s to obtain the plaintext p∈ [symbol] q is achieved as follows: first, compute the summation (mod q) of each j-th random number randⱼ, if the corresponding secret key coefficient sⱼ=1, i.e. Σⱼ₌₁^{N}sⱼrandⱼ(mod q); subtract the summation (mod q) to the last component of the ciphertext c, which is the LWE summation value suml.

$$p = lsum - {\sum }_{j = 1}^{N} {s}_{j} {rand}_{j} ( mod q ) .$$

The obtained value is the decrypted value, i.e. the plaintext p.

Now, with reference to the specific application to metering, considering the encrypted energy value, or balance, E(b), i.e. a generic encrypted energy value b (which may correspond to a i-th energy value b₁ measured by a smart meter SMᵢ or a sum of energy values), as indicated above LWE summation value lsumb of the energy is: lsumb=b+Σⱼ₌₁^{N}sⱼrandⱼ+e (mod q) resulting in the cyphertext: c=(rand1, rand2, . . . , rand_{N}, lsumb).

It is noted here that the zero encrypted E(0), i.e. the encryption of energy value b=0, has the following result for the LWE summation value sumlb: lsumb(0)=Σ_{J=1}^{N}sⱼrandⱼ+e (mod q).

So the encrypted energy balance can be expressed as: E(b)=E(0)+b

Actually, as the zero encrypted E(0), i.e. encrypted by FHE encryption, contains random elements, it is possible to say that there are multiple zero encrypted components, called Zero Tokens, Eⱼ(0) (each representing 0), j being an index going from 1 to N, the number of random numbers.

For all the zero encrypted components E (0): sumlb (0)=Σⱼ₌₁^{N}sⱼrandⱼ+e (mod q)

Due to the homomorphic properties, considering a number m of different Zero Tokens Eⱼ(0), a summation modulo q over the number m of different Zero Tokens Eⱼ(0), of the Zero Tokens Eⱼ(0) multiplied by a respective weight ay, which may be any integer∈ [symbol] q, with l index from 1 to m, i.e. a random scalar, is: Σₗ₌₁^{m} aₗEₗ(0) (mod q) and it is still a Zero Token Eₗ(0).

Therefore, data encryption of a generic energy value b can then be obtained as: E(b)=b+Σₗ₌₁^{m}aₗEₗ(0) (mod q) i.e., the summation modulo q over the number m of different Zero Tokens Eₗ(0) plus the energy value b as plaintext.

The above operation can be realized as follows. The 1-th Zero Token Eⱼ(0), l index from 1 to m, corresponds to a l-th cyphertext component, cₗ: Eₗ(0)=cₗ=(rand₁ₗ, rand₂ₗ, . . . , rand_{N}, sumlbₗ)

The encrypted energy balance E(b) elements, the 1-th Zero Token random energy element randᵢₗ and the 1-th LWE Zero Token summation value element lsumbₗ, both over the m selected Zero Tokens are computed as follows: rand_{ib}=Σₗ₌₁^{m}aₗrandᵢₗlsumb_{b}=b+Σₗ₌₁^{m}aₗsumlbₗ

Here Zero Token random energy element randᵢₗ and the LWE Zero Token summation value element lsumb_{b} stand for random element and summation value element calculated with the Zero Tokens, i.e. over the m selected Zero Tokens and their weights.

Actually, only the LWE Zero Token summation value element lsumb_{b} depends on the value of the measured energy b that represents the confidential information.

Hence, only the LWE Zero Token summation value lsumb_{b} strictly needs to be computed by the secure element.

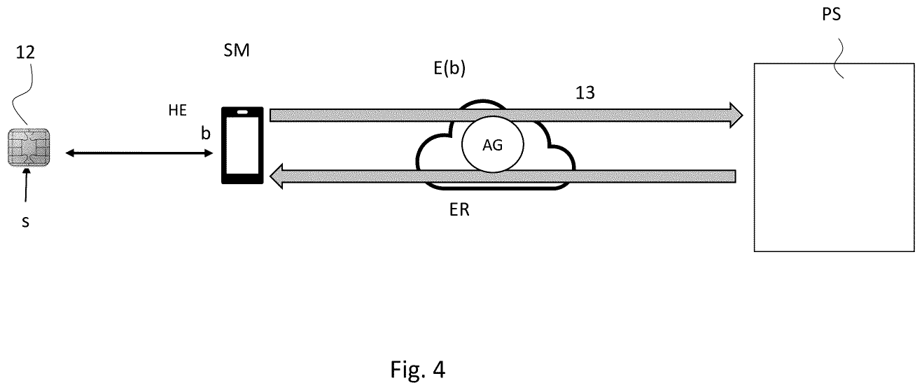

In FIG. 4 it is described an architecture which uses Secure Elements. This architecture in embodiments may store the secrete key s in the Secure Element. In embodiments this architecture may implement the Zero token approach, which can be used to improve the bandwidth and computation load of using the fully homomorphic encryption.

With 12 is indicated a Secure Element which is associated to the Smart Meter SM, e.g. is included within the Smart Meter SM, which stores the secret key s. The smart meter SM measures an energy value b, e.g. energy value and performs fully homomorphic encryption HE (corresponding to operation 210 described in FIG. 5) of the measured energy value b using the secret key s in the Secure Element 12, which is then transmitted encrypted, e.g. as encrypted energy value E(b), to the power station PS, over a communication network 13, which includes at least a respective aggregator, e.g. AG1.

Also, it is shown that the results ER, data, or commands (for instance, related to the managing functions F, possibly, or also to repopulate tokens) may be transmitted from the power station PS to the smart meter SM, which may be encrypted by standard cryptography (e.g., elliptic curves cryptography). A part from performing operations of the managing functions F. In embodiments, however, the disclosed method does not require sending back the encrypted results ER and decryption HD. Creation of a privacy-protected communication channel back from the power station PS to the smart meter SM is an additional aspect.

The number N of random numbers may be 630 so the secret key s is 630 bit, resulting in cyphertexts of around 5 kb of size.

In embodiments, a Secure Element approach may be thus used, which provides that the secret key s is stored in a secure element in the smart meter SM. A secure element corresponds to a secure operating system in a tamper-resistant processor chip or secure component. It may exist in different forms, devices such as smart card, SIM/UICC, smart microSD or as part of a larger device as an embedded or integrated Secure Element.

As ciphertexts are so huge, massive reading of data may be an issue, e.g., for the bandwidth of data transmission therefore a zero-token approach is taken. Therefore, the secret key s, which may be a bootstrapping key, is generated, e.g. in a separate processor or key generator, before issuance and delivered to the server 11 or to the cloud which then supplies the secret key s, e.g. to the power station PS, independently.

It is underlined that with the zero-token approach, the Secure Element, e.g. 12, does not know the secret key s, only the Power Station knows the secret key s.

For the pre-shared zero tokens architecture a precondition is that the server 11 agrees with each secure element a set of Zero Tokens (Eₗ(0)).

By way of example, the secure element 12 may have pre-stored 32 Zero Tokens (Eₗ(0)), (each identified with a serial number, i.e. identifier (idₗ). The storage of the Zero Tokens (Eₗ(0)) is performed previously in the Secure Element 12 with respect to encryption operations, in particular at the creation of the Secure Element, e.g. initialization or personalization of profiles in the Secure Element.

Regarding the encryption in Secure element, the Secure Element 12 randomly selects a subset of the zero tokens e.g., 4 zero tokens) and creates 4 respective random scalars (a₁ . . . a₄), i.e. weights, then it creates a vector containing: E(b)=(a1, a2, . . . , a₄, id1, id2, . . . , id₄, lsumb) where the encrypted sum energy balance element lsumb is: lsumb=b+Σⱼ₌₁^{m}aₗsumₗ l ranging from 1 to 4, which in the example is the number of zero tokens chosen among the 32 pre-stored zero tokens.

In the above example, given sizeof( ) a function which measures the byte size of value, if sizeof(a₁) is 1, sizeof(idᵢ) is 2, sizeof(E(b)) is 20 bytes (compared to the 5 kb indicated above, without the Zero Token approach).

The identifier idᵢ may be represented by two bytes. For instance, a database may contain random weight values known by the Power Station PS; then on the Secure element 12 in the first smart meter SM1 it may be associated a given sets of random weight values, e.g. randoms with identifiers idᵢ, e.g. 3232, 3321, 2112, 5532, i.e. with identifiers idᵢ that are unique in the system, differently from the case they were numbered from 0 to 31 for each Secure Element 12). The server 11 looks up the identifier idᵢ, e.g. 3232 and associates with the random (231231, 432313, 53234234, 2312135, 1263243 . . . ) of about 5 kb. In other words, the server may have a number of the sets, e.g. 1024, each of them comprising a number of random bytes, e.g., 630, of a given length, e.g., 8 bytes. Thus, 1024 random correspond to about 5 kb. Instead of communicating such 5 kb of random values, the Secure element 12 indicates only which of the 1024 random values has been used by that Secure element for that zero-token encoding. The indication is performed through a 2-bytes index which is different for each random value. To increase the entropy, the Secure Element 12 may have a number, e.g., 32 of random values of 5 kb stored (so 32 of the 1024 that are spread in the system), and for each data sending it selects randomly four randoms in the set; it performs the operation locally at the Secure Element using the four 5 kb random value selected but when it sends the result it sends only the corresponding four 2-bytes index values in the range 0 . . . 1023 that must be unique in the system.

The encrypted sum energy balance element lsumb is 8 byte (64 bit)

The aggregator, e.g. AG1, for instance receives encrypted measured values E(bᵢ), i.e. readings from the various secure elements 12 or meters SMᵢ.

It performs the aggregation, calculating the aggregated summation agsum: agsum=Σ_{i′=K1}^{K2}lsumbᵢ, as the summation of LWE summation value lsumb over the respective subset (b₁ . . . b₃) or, (b₄ . . . b₇) of smart meters (thus i′ is the subset index, going from K1 to K2, where K1=K2 for the first subset (b₁ . . . b₃) and K1=4, K2=7 for the second subset (b₄ . . . b₇) in the example) and sends to the power station PS: all the scalar weights aᵢ, all the token identifiers idᵢ, the resulting aggregated sum agsum.

Thus, are sent to the power station PS all the corresponding scalar weights, aᵢ, identifiers (id1, id2, . . . , id₄) and a total sum agsum of each encrypted sum energy value sumlb of the corresponding subset (b₁ . . . b₃), (b₄ . . . b₇) of smart meters.

Regarding the decryption at the power station PS, using the pre-shared token identifier id and all the various weights, the power station PS computes: b=lsumb−Σₗ₌₁^{m}aₗagsumbₗ where the scalar weights aⱼ and sumⱼ are related to all the tokens aggregated by the aggregator AG.

In FIG. 5 it is shown a diagram flow exemplary of an embodiment of the method for smart metering of energy consumption values, which is indicated as a whole by the numeric reference 1000.

Also with reference to FIG. 3, the method 1000 for smart metering of energy consumption values, comprises a first operation of measuring 100 a set of measured energy values, b₁ . . . b₇, consumed by respective energy consuming environments by respective smart energy meters, SM₁ . . . SM₇, and then supplying 200 the measured energy values b₁ . . . b₇ to at least an energy consumption using entity, e.g. the power station PS located remotely with respect to the energy consuming environments, finally performing 300 one or more energy-related functions F, e.g. energy management functions F, for instance, monitoring or energy distribution controlling or billing, on the basis of the set of measured energy values b₁ . . . b_{y}, at the energy consumption using entity, e.g. power station PS.

The disclosed method specifically comprises that the supplying 200 includes
encrypting 210 the measured energy value b₁ . . . b₇ by a fully homomorphic encryption, or FHE, using a secret key s to obtain a plurality of respective encrypted measured energy values, E(b₁) . . . E(b₇), aggregating 220 the encrypted measured energy values E(b₁) . . . E(b₇) of at least a subset b₁ . . . b₃, b₄ . . . b₇, in the example there are to pertaining aggregators AG1, AG2, respectively, of the set of the encrypted measured energy values E(b₁) . . . E(b₇), in a respective encrypted aggregated value E(b₁+b₂+b₃), E(b₄+b₅+b₆+b₇), performing a sum of the respective encrypted measured energy values E(b₁) . . . E(b₇) of the at least a subset b₁ . . . b₃, b₄ . . . b₇, the encrypting 210 being performed before the aggregating 220, in particular at the smart energy meters, SM₁ . . . SM₇, supplying 230 the at least one encrypted aggregated value E(b₁+b₂+b₃), E(b₄+b₅+b₆+b₇) to the at least an energy consumption using entity, e.g. power station PS, located remotely with respect to the energy consuming environments, which is configured to receive, 500 the secret key (s) from a separated entity, in particular the server 11 or a cloud, decrypting 240 using the secret key s at the at least an energy consumption using entity, PS, the at least one encrypted aggregated value E(b₁+b₂+b₃), E(b₄+b₅+b₆+b₇) obtaining a decrypted sum bₜₒₜ of respective measured energy values b₁ . . . b₇ performing 300 one or more energy-related functions, e.g. energy management functions F, on the basis of the decrypted sum bₜₒₜ of the respective measured energy values b₁ . . . b₇ at the energy consumption using entity PS.

The encrypting 210 preferably comprises given an integer number, N, and a ring defining integer, i.e. q=2^{k}, identifying a ring [symbol] q of integers modulo the ring defining integer q, i.e. mod q; generate a number N of random numbers, e.g. (rand1, rand2, . . . , rand_{N}), i.e. belonging to a set of N-vectors over the ring ( [symbol] q); compute a summation modulo the ring defining integer q of each j-th random number rand; in the number N of random numbers (rand1, rand2, . . . , rand_{N}) while a corresponding secret key binary coefficient (sⱼ) is equal to one; to the summation, also add an energy value (b) to encrypt as plaintext p; finally, add a Gaussian noise e, obtaining a LWE summation value sumlb for energy, as the sum of the energy value b and the summation modulo the ring defining integer q plus the noise e, obtain a LWE ciphertext c as a vector comprising as elements the random numbers and the LWE summation as last element (rand1, rand2, . . . , rand_{N}, sumlb), corresponding to an encrypted energy value E(b), and the decryption 240 using the secret key s at the at least an energy consumption using entity, e.g power station PS, comprising: computing a summation modulo the ring defining integer q of each j-th random number rand; in the number N of random numbers (rand1, rand2, . . . , rand_{N}), while a corresponding secret key binary coefficient sⱼ is equal to one; subtracting the summation modulo the ring defining integer q from the last component of the ciphertext c corresponding to an encrypted energy value E(b), which is the LWE summation value sumlb, obtaining an energy decrypted value b.

As mentioned, in embodiments, the using entity PS is a power station which, preferably, distributes 300 energy to the environments as a function of the decrypted sum bₜₒₜ of the respective measured energy values, b₁ . . . b₇) to the environments. In variant embodiments, the using entity PS may be a water distribution station, a gas distribution station, or any utility distribution station, or any entity that uses the data value in aggregated form, which has to be encrypted, e.g., for privacy reasons.

Also, in variant embodiments, the smart energy meters SM₁ . . . SM₇ may comprise a Secure element 12 and the separated entity 11 shares with each secure element 12 a set of Zero Tokens E(0), corresponding to an encrypted zero value, identified by a respective identifier idⱼ, stored at the creation of the Secure Element 12, during the encryption 210, the Secure Element is configured to randomly select a subset of the set of zero tokens Eⱼ(0), and generates respective random scalar weights a₁ . . . a₄ and a vector containing the scalar weights the identifier and the encrypted sum energy balance element, a1, a2, . . . , a₄ and id1, id2, . . . , id₄, sum, which are sent to the using entity PS through the respective aggregator, e.g. AG1 or AG2, decrypting, 240, at the using entity PS using the pre-shared token identifier id1, id2, . . . , id₄ and the weights a1, a2, . . . , a₄ to compute the total measured energy as subtraction of the result sum_{b} to the last component of the encrypted energy values, i.e. E(b).

In general, also without the Zero Token approach, each smart meter SM may be configured to access a secure element 12 storing the secret key s, in particular the secure element 12 may be comprised in the smart meter SM.

As specified, in general, the solution described refers to a method for transmitting data values, which may correspond in preferred to utility, in particular, energy values (b1 . . . b₇) privacy protected by encryption, e.g., FHE, from a set of data collecting stations SM₁ . . . SM₇, preferably. smart metering stations, collecting, in particular by measuring, respective data values from a respective environment and transmitting the respective set of data values, e.g., utility, in particular, energy values (b₁ . . . b₇) (b₁ . . . b₇) to a using entity, e.g. the power station PS located remotely with respect to the collecting stations SM₁ . . . SM₇. Thus, while preferably data values are utility consumption, in particular energy consumption, values, measured in utility consumption, in particular energy consumption, environments, the data values could be any data value that can be collected in an environment and can be aggregated by sum in an aggregator before being sent to the using station.

Thus, based on the above, the advantages of the described solution are clear.

The solution described here allows the protection of the sensitive information that may be associated with the consumption data using a fully homomorphic encryption where the secret key is not known to the aggregators but is made known independently at the using entity, e.g., power station. The use of Zero Token advantageously lowers the bandwidth requirements of the fully homomorphic encryption.

Of course, without prejudice to the principle of the invention, the details of construction and the embodiments may vary widely with respect to what has been described and illustrated herein purely by way of example, without thereby departing from the scope of the present invention, as defined by the ensuing claims.

What is claimed is:

1. A method for transmitting data values for privacy protection, the method comprising:
collecting, by a plurality of collecting stations, data values associated with a respective environment of each collecting station;
encrypting, by each collecting station, each data value using a secret key and a fully homomorphic encryption (FHE) technique to generate a plurality of encrypted data values by the plurality of collecting stations;
aggregating, by an aggregator, a subset of the plurality of encrypted data values to generate an encrypted aggregated value of the subset by summing the encrypted data values associated with the subset;
communicating, to a using entity, the encrypted aggregated value;
receiving, by the using entity, the secret key from a server or a cloud device, the using entity located remotely with respect to the plurality of collecting stations;
decrypting, by the using entity, the encrypted aggregated value using the secret key to obtain a decrypted sum of data values; and
performing, by the using entity, a data related function on the decrypted sum of the data values.

2. The method of claim 1, wherein the data values are utility consumption values, and wherein the collecting station is a smart meter, the method further comprising:
measuring, by the smart meter, the utility consumption value consumed by utility consuming environment;
supplying, by smart meters, the utility consumption values to the using entity; and
performing the data related function on the utility consumption values at the using entity.

3. The method of claim 1, wherein the data values are energy consumption values and the collecting station is a smart energy meter.

4. The method of claim 1,
wherein encrypting each data value using the secret key and the fully homomorphic encryption technique comprises:
identifying a ring of integers modulo the ring defining integer;
generating N random numbers belonging to a set of N-vectors over the ring, where N is an integer;
computing a summation modulo for each random number of the N random numbers where a corresponding secret key binary coefficient equals one;
adding an encrypting data value to the summation modulo to encrypt it as plaintext;
adding Gaussian noise to the summation modulo and the encrypting data value to generate a learning with errors (LWE) summation value; and
generating an LWE ciphertext comprising the N random numbers and the LWE summation value, the LWE ciphertext being a vector value, the LWE summation value being a last element of the LWE ciphertext, and
wherein decrypting the encrypted aggregated value comprises:
computing the summation modulo for each random number where the corresponding secret key binary coefficient equals one; and
subtracting the summation modulo from the last element of the LWE ciphertext to generate the decrypted sum of data values.

5. The method of claim 1, wherein the using entity is a power station that distributes energy to the environments as a function of the sum of the data values.

6. The method of claim 1,
wherein each collecting station includes a secure element,
wherein the server or cloud device shares with each secure element a set of zero-tokens corresponding to an encrypted zero data value that is encrypted by the encryption operation, wherein each encrypted zero data is identifiable by an identifier previously stored in the secure element,
wherein, during the encryption, each secure element randomly selects a subset of the set of zero-tokens to generate random scalar weights, a vector containing the scalar weights, the identifiers, and the encrypted sum of data values sent to the using entity through the aggregator, and
wherein the method further comprises decrypting, by the using entity, the encrypted aggregated value using the identifiers, the random scalar weights, and the vector containing the scalar weights to compute the decrypted sum of data values.

7. The method of claim 6, wherein communicating the encrypted aggregated value comprises communicating, by the aggregator to the using entity, the random scalar weights, the identifiers, and the sum of data values.

8. The method of claim 1, wherein generating the encrypted aggregated value is performed without decrypting encrypted data values.

9. The method of claim 1, wherein the secret key is made available for decryption only to the using entity.

10. The method of claim 1, wherein the secret key is stored in a secure element accessible to each collecting station for performing encryption.

11. A system for transmitting data values for privacy protection, the system comprising:
a plurality of collecting stations, each collecting station configured to:
collect data values associated with a respective environment of each collecting station, and
encrypt each data value using a secret key and a fully homomorphic encryption (FHE) technique to generate a plurality of encrypted data values by the plurality of collecting stations;
an aggregator configured to aggregate a subset of the plurality of encrypted data values to generate an encrypted aggregated value of the subset by summing the encrypted data values associated with the subset; and
a using entity located remotely with respect to the collecting stations, the using entity configured to:
receive the encrypted aggregated value,
receive the secret key from a server or a cloud device;
decrypt the encrypted aggregated value using the secret key to obtain a decrypted sum of data values; and
perform a data related function on the decrypted sum of the data values.

12. The system of claim 11, wherein the data values are utility consumption values, and wherein the collecting stations are smart meters, the smart meters configured to measure the utility consumption values consumed by utility consuming environments.

13. The system of claim 11, wherein the data values are energy consumption values and the collecting stations are smart energy meters, and wherein the using entity is a power station configured to distribute energy to the environments as a function of the sum of the data values.

14. The system of claim 11,
wherein encrypting each data value using the secret key and the fully homomorphic encryption technique comprises:
generating N random numbers belonging to a set of N-vectors, where N is an integer;
computing a summation modulo for each random number of the N random numbers where a corresponding secret key binary coefficient equals one;
adding an encrypting data value to the summation modulo to encrypt it as plaintext;
adding Gaussian noise to the summation modulo and the encrypting data value to generate a learning with errors (LWE) summation value; and
generating an LWE ciphertext comprising the N random numbers and the LWE summation value, the LWE ciphertext being a vector value, the LWE summation value being a last element of the LWE ciphertext, and
wherein decrypting the encrypted aggregated value comprises:
computing the summation modulo for each random number where the corresponding secret key binary coefficient equals one; and
subtracting the summation modulo from the last element of the LWE ciphertext to generate the decrypted sum of data values.

15. The system of claim 11,
wherein each collecting station includes a secure element,
wherein the server or cloud device shares with each secure element a set of zero-tokens corresponding to an encrypted zero data value that is encrypted by the encryption operation, wherein each encrypted zero data is identifiable by an identifier previously stored in the secure element,
wherein, during the encryption, each secure element randomly selects a subset of the set of zero-tokens to generate random scalar weights, a vector containing the scalar weights, the identifiers, and the encrypted sum of data values sent to the using entity through the aggregator, and
wherein the using entity is configured to compute the decrypted sum of data values using the identifiers, the random scalar weights, and the vector containing the scalar weights.

16. The system of claim 11, wherein generating the encrypted aggregated value is performed without decrypting encrypted data values, and wherein the secret key is made available for decryption only to the using entity.

17. The system of claim 11, wherein the collecting station is configured to access a secure element storing the secret key.

18. A smart energy meter configured to:
collect energy consumption values; and
encrypt each data value using a secret key and a fully homomorphic encryption (FHE) technique to generate an encrypted data value,
wherein the encrypted data value is aggregated by an aggregator with encrypted data values of other smart energy meters to generate an encrypted aggregated value by summing the encrypted data values, and
wherein the encrypted aggregated value is communicated to a power station configured to obtain a decrypted sum of data values using the secret key communicated by a server or a cloud device to perform a data related function on the decrypted sum of data values.

19. The smart energy meter of claim 18,
wherein encrypting each data value using the secret key and the fully homomorphic encryption technique comprises:
generating N random numbers belonging to a set of N-vectors, where N is an integer;
computing a summation modulo for each random number of the N random numbers where a corresponding secret key binary coefficient equals one;
adding an encrypting data value to the summation modulo to encrypt it as plaintext;
adding Gaussian noise to the summation modulo and the encrypting data value to generate a learning with errors (LWE) summation value; and
generating an LWE ciphertext comprising the N random numbers and the LWE summation value, the LWE ciphertext being a vector value, the LWE summation value being a last element of the LWE ciphertext.

20. The smart energy meter of claim 18, wherein each collecting station includes a secure element, and wherein the server or cloud device shares with each secure element a set of zero-tokens corresponding to an encrypted zero data value that is encrypted by the encryption operation, wherein each encrypted zero data is identifiable by an identifier previously stored in the secure element, and wherein, during the encryption, each secure element randomly selects a subset of the set of zero-tokens to generate random scalar weights, a vector containing the scalar weights, the identifiers, and the encrypted sum of data values.
